(19) United States
(12) Patent Application Publication
(10) Pub. No.: US 2009/0206302 A1
(43) Pub. Date: Aug. 20, 2009

(54) HYDROGEN-ABSORBING ALLOY FOR AN ALKALINE STORAGE BATTERY

(75) Inventors: PATRICK BERNARD, Bordeaux (FR); Bernard Knosp, Bordeaux (FR); Michel Latroche, Saint-Cyr-L'ecole (FR); Amelie Ferey, Bures-Sur-Yvette (FR)

Correspondence Address: SUGHRUE MION, PLLC, 2100 PENNSYLVANIA AVENUE, N.W., SUITE 800, WASHINGTON, DC, 20037, US

(73) Assignees: SAFT, Bagnolet (FR); CENTRE NATIONAL DE LA RECHERCHE, Paris Cedex 16 (FR)

(21) Appl. No.: 12/430,451

(22) Filed: Apr. 27, 2009

Related U.S. Application Data
(62) Division of application No. 11/679,504, filed on Feb. 27, 2007.

(30) Foreign Application Priority Data
Feb. 28, 2006 (FR) 0601751

(51) Int. Cl. H01B 1/02

(52) U.S. Cl. 252/519.15

(57) ABSTRACT

Therefore the invention provides a hydrogen-absorbing alloy comprising at least one A₅B₁₉ type crystalline phase having the formula R_{1-y}Mg_{y}Ni_{3.8±0.1-z}M_{z}, in which R represents one or more elements chosen from La, Ce, Nd or Pr; M represents one or more elements chosen from Mn, Fe, Al, Co, Cu, Zr, Sn and M does not contain Cr; 0≦y≦0.30; z≦0.5. The invention extends to an electrode comprising an active ingredient comprising said alloy. It also extends to a nickel metal hydride alkaline storage battery the negative electrode of which comprises said alloy. The invention also relates to the process for the manufacture of said alloy.

This is a divisional of application Ser. No. 11/679,504 filed Feb. 27, 2007. The entire disclosure of the prior application, application Ser. No. 11/679,504 is considered part of the disclosure of the accompanying divisional application and is hereby incorporated by reference.

### TECHNICAL FIELD

A subject of the invention is a hydrogen-absorbing alloy comprising at least one crystalline phase of A₅B₁₉ type, and an alkaline storage battery of nickel metal hydride type comprising at least one negative electrode (anode) containing said alloy. Such a battery possesses a higher electrochemical capacity than the nickel metal hydride batteries of the prior art as well as a longer life.

### STATE OF THE ART

Portable applications have increasing requirements for energy volume density and power, at a low cost as in wireless tools for example. At present the batteries reach a limitation in terms of energy volume density, due to the optimization of the energy volume densities of each of the two electrodes constituting the battery: positive electrode based on nickel hydroxide and negative electrode based on hydrogen-absorbing alloy AB₅. The capacity by mass of an AB₅ type alloy is limited to 300-320 mAh/g.

When optimization of the battery's capacity is carried out, it is to the detriment of its life span. Conversely it is possible to carry out optimization of the life span of the battery, but to the detriment of the capacity by volume.

In order to increase the capacity by volume, compositions such as the AB₂ alloy families have been studied. However, although their initial capacity is greater than that of an AB₅ alloy, I their power and their life spans are considerably reduced. Recently certain manufacturers have proposed the use of an A₂B₇ type alloy. The following documents describe A₂B₇ type alloys.

JP2001-316744 describes a hydrogen-absorbing alloy having the formula Ln₁₋ₓMgₓ(Ni_{1-y}T_{y})_{z} in which Ln is at least one element chosen from the lanthanide series, Ca, Sr, Sc, Y, Ti, Zr and the quantity of lanthanum represents from 10 to 50 atomic % of the lanthanides.

T is at least one element chosen from Li, V, Nb, Ta, Cr, Mo, Mn, Fe, Co, Al, Ga, Zn, Sn, In, Cu, Si, P and B; and x, y and z satisfy the relationships:

0.05≦x<0.20; 0≦y≦0.5 and 2.8≦z≦3.9.

JP2002-069554 describes a hydrogen-absorbing alloy of formula R₁₋ₐMgₐNi_{b}Co_{c}M_{d} in which R represents at least two rare earth elements. R can also contain yttrium. M represents one or more elements chosen from Mn, Fe, V, Cr, Nb, Al, Ga, Zn, Sn, Cu, Si, P and B. The stoichiometric indices a, b, c and d satisfy the following relationships:

0.15<a<0.35; 0≦c≦1.5; 0≦d≦0.2; and 2.9<b+c+d<3.5.

EP-A-1 026 764 describes a hydrogen-absorbing alloy of formula AMₓ, where A can be a rare earth element and/or magnesium and M is one or more elements which can be chosen from Cr, Mn, Fe, Co, Ni, Al, Cu and Sn and x satisfies the relationship: 2.7<x<3.8.

U.S. Pat. No. 6,214,492 describes a hydrogen-absorbing alloy comprising at least one crystalline phase consisting of a unit cell possessing at least one A₂B₄ type sub-cell, and at least one AB₅ type sub-cell. This alloy can optionally comprise a type AB₃ or type AB_{3.5} crystalline phase.

US2004/0134569 describes a hydrogen-absorbing alloy of formula Ln₁₋ₓMgₓNi_{y-a}Alₐ in which Ln is at least one rare earth element; and x, y and a satisfy the relationships:

0.05≦x<0.20; 2.8≦y≦3.9 and 0.10≦a≦0.25.

US2004/0146782 describes a hydrogen-absorbing alloy of formula Ln₁₋ₓMgₓNi_{y-a}Alₐ in which Ln is at least one rare earth element; M is chosen from the group consisting of Al, V, Nb, Ta, Cr, Mo, Mn, Fe, Co, Ga, Zn, Sn, In, Cu, Si and P; and x, y and a satisfy the relationships:

0.05≦x<0.20; 2.8≦y≦3.9 and 0.10≦a≦0.50.

US2005/0100789 describes a hydrogen-absorbing alloy of formula RE₁₋ₓMgₓNi_{y}Al_{z}Mₐ in which RE is a rare earth element; M is an element other than a rare earth, and x, y, z and a satisfy the relationships:

0.10≦x<0.30; 2.8≦y≦3.6; 0≦z≦0.30 and

3.0≦y+z+a≦3.6.

US2005/0175896 describes a hydrogen-absorbing alloy of formula Ln₁₋ₓMgₓNi_{y-a}Alₐ in which Ln is a rare earth element; and x, y and a satisfy the relationships:

0.05≦x<0.20; 2.8≦y≦3.9; and 0.10≦a≦0.25.

Preferably, a part of the rare earth element or Ni is substituted by at least one element chosen from the group consisting of V, Nb, Ta, Cr, Mo, Mn, Fe, Co, Ga, Zn, Sn, In, Cu, Si, P and B.

US2005/0164083 describes a hydrogen-absorbing alloy of formula Ln₁₋ₓMgₓNi_{y-a}Alₐ in which Ln is at least one rare earth element, and x, y and a satisfy the relationships:

0.15≦x≦0.25; 3.0≦y≦3.6; and 0<a≦0.3.

Preferably, a part of the rare earth element or Ni is substituted by at least one element chosen from the group consisting of V, Nb, Ta, Cr, Mo, Mn, Fe, Co, Ga, Zn, Sn, In, Cu, Si, P and B.

JP 09-194971 describes a hydrogen-absorbing alloy represented by the formula: R₂(Ni_{7-X-Y-Z}Mn_{X}A_{Y}B_{Z})ₙ in which R is a rare earth element or a misch metal; A is one or more elements chosen from Co, Cr, Fe, Al, Zr, W, Mo, and Ti; B is one or more elements chosen from Cu, Nb and V; X, Y, Z and n satisfy the relationships:

0.3≦X≦1.5; 0≦Y≦1.0; 0≦Z≦1.0; Y+Z≦1.0; 0.96≦n≦1.1.

EP-A-0 783 040 describes a hydrogen-absorbing alloy of formula

(R₁₋ₓLₓ) (Ni_{1y}M_{y})_{z} in which R represents La, Ce, Pr or Nd; L represents Gd, Tb, Dy, Ho, Er, Tm, Yb, Lu, Y, Sc, Mg or Ca; M represents Co, Al, Mn, Fe, Cu, Zr, Ti, Mo, Si, V, Cr, Nb, Hf. Ta, W, B or C; and x, y and z satisfy the relationships:

0.05≦x≦0.4; 0≦y≦0.5; and 3.0≦z≦4.5.

JP 2004-115870 describes a hydrogen-absorbing alloy of formula Ln₁₋ₓMgₓNi_{y}M_{z} in which Ln is Y, Sc or a rare earth element; M is Co, Mn, Al, Fe, V, Cr, Nb, Ga, Zn, Sn, Cu, Si, P or B, and x, y, and z satisfy the relationships:

0.1≦x≦0.5; 2.5≦y≦3.5 and 0≦z<0.5; and 3.0≦y+z≦3.5.

However, although the initial capacity of the A₂B₇ alloys is greater than that of an AB₅ alloy and comparable to that of an AB₂ alloy, their life span is limited.

A nickel metal hydride type alkaline storage battery is therefore sought, possessing a higher capacity than that of the batteries of the prior art as well as a long life span.

### SUMMARY OF THE INVENTION

The invention therefore provides a hydrogen-absorbing alloy comprising at least one A₅B₁₉ type crystalline phase having the formula R_{1-y}Mg_{y}Ni_{3.8±0.1-z}M_{z}, in which:

R represents one or more elements chosen from

La, Ce, Nd or Pr;

M represents one or more elements chosen from

Mn, Fe, Al, Co, Cu, Zr, Sn and M not containing Cr;

0≦y≦0.30;

z≦0.5.

The invention extends to an electrode comprising an active material comprising said alloy. It also extends to a nickel metal hydride alkaline storage battery comprising at least one negative electrode comprising said alloy.

The invention also relates to the production process of said alloy.

### DETAILED DISCLOSURE OF EMBODIMENTS OF THE INVENTION

The hydrogen-absorbing alloy according to the invention contains at least one A₅B₁₉ type crystalline phase, corresponding to the formula:

R_{1-y}Mg_{y}Ni_{3.8±0.1-z}M_{z}, where

R represents one or more elements chosen from La, Ce, Nd or Pr;

M represents one or more nickel substituents chosen from the elements Mn, Fe, Al, Co, Cu, Zr, Sn, and M does not contain the element Cr.

0≦y≦0.30;

z≦0.5.

The presence of the element Cr as a nickel substituent is excluded from the invention as the presence of Cr reduces the power supplied by the battery.

The composition of the alloy can be confirmed by elementary analysis (atomic absorption, inductive plasma technique), X-ray diffraction, electron probe microanalysis (EPMA) with wavelength dispersive spectroscopy (WDS).

According to a preferred embodiment, the sum of the stoichiometric indices of nickel and M is 3.8.

According to an embodiment, y≦0.25.

According to an embodiment, y>0.15.

According to an embodiment, z≦0.30.

According to an embodiment, the stoichiometric index of each of the nickel substituents is less than or equal to 0.20; preferably it is less than or equal to 0.15.

According to an embodiment, M represents one or more elements chosen from Co, Al and Mn.

According to a preferred embodiment, M is CoₐAl_{b}, with a≦0.15 and b≦0.15.

According to an embodiment, the hydrogen-absorbing alloy comprises the A₅B₁₉ crystalline phase as described previously and its overall composition has the formula:

R₁₋ᵤMgᵤNiₜ₋ᵥMᵥ, where

0≦u≦0.25;

3.5≦t≦4.3;

v≦0.5.

According to a preferred embodiment, the proportion of A₅B₁₉ crystalline phase represents at least 50% by volume of the alloy.

According to a second preferred embodiment, the equilibrium pressure at 40° C. for 1% by mass of hydrogen inserted is less than 1.5 bar.

According to an embodiment, the size of the hydrogen-absorbing alloy particles is characterized by a Dv 50% of 30 to 120 μm, preferably of 50 to 100 μm.

According to another embodiment, the size of the particles of hydrogen-absorbing alloy is characterized by a Dv 50% of 120 to 200 μm.

The alloy of the invention can be prepared by the following three processes:
by melting the constitutive single elements of the alloy followed by slow freezing (standard metallurgy), by quenching (rapid freezing) as strip casting on a single roll or between double rolls, by hyperquenching (ultra-rapid cooling) using melt spinning techniques or rapid freezing on a single roll or between doubles rolls (“planar flow casting”)
by powder metallurgy (sintering) from single elements or prealloys,
by mechanosynthesis.

Other alloy manufacturing processes can also be envisaged.

The alloy of the invention may have undergone annealing.

The invention also proposes an electrode comprising an active ingredient comprising the alloy as described previously. The invention extends to a nickel metal hydride alkaline storage battery comprising at least one negative electrode comprising the alloy according to the invention.

It is advantageous, in order to obtain a still longer life span of the negative electrode, to mix a yttrium compound with the active ingredient containing the alloy. This compound can be an yttrium oxide, hydroxide or salt.

The yttrium-based compound is chosen from a non-exhaustive list comprising an yttrium-based oxide such as Y₂O₃, an yttrium-based hydroxide such as Y(OH)₃ or a yttrium-based salt. Preferably, the yttrium-based compound is yttrium oxide Y₂O₃.

The yttrium-based compound is mixed with the alloy in a proportion such that the mass of yttrium represents from 0.1 to 2% of the mass of the alloy, preferably from 0.2 to 1% of the mass of alloy, preferably also from 0.2 to 0.7% of the mass of the alloy.

The process of addition of the yttrium-based compound to the active ingredient during the manufacture of the anode is simple to implement industrially. It does not require complex devices.

The anode is manufactured by covering an electrically conductive support with a paste made up of an aqueous mixture of the composition of active ingredient according to the invention and additives.

The support can be a nickel foam, a flat or three-dimensional perforated strip made of nickel or nickel-plated steel.

The additives are intended to facilitate the use or the performances of the anode. They can be thickeners such as carboxymethyl cellulose (CMC), hydroxypropylmethyl cellulose (HPMC), polyacrylic acid (PAA), poly(ethylene oxide) (PEO). They can also be binders such as butadiene-styrene (SBR) copolymers, polystyrene acrylate (PSA), polytetrafluoroethylene (PTFE). They can also be polymer fibres, such as polyamide, polypropylene, polyethylene, etc., in order to improve the mechanical properties of the electrode. They can also be conductive agents such as nickel powder, carbon powder or fibres, nanotubes.

Advantageously, the anode is covered with a surface layer intended to improve high-speed discharge and/or recombination with oxygen at the end of charging. The invention also relates to a nickel metal hydride alkaline storage battery comprising said at least one anode.

The battery according to the invention typically comprises at least one anode, at least one nickel cathode, at least one battery separator and an alkaline electrolyte.

The cathode is constituted by the active cathode mass deposited on a support which can be a sintered support, a nickel foam, a flat or three-dimensional perforated strip made of nickel or nickel-plated steel.

The active cathode mass comprises the active cathode ingredient and additives intended to facilitate its implementation or its performances. The active cathode ingredient is a nickel hydroxide Ni(OH)₂ which can be partially substituted by Co, Mg and Zn. This hydroxide can be partially oxidized and can be coated with a surface layer based on cobalt compounds.

Among the additives there can be mentioned, without this list being exhaustive, carboxymethyl cellulose (CMC), hydroxypropylmethyl cellulose (HPMC), hydroxypropyl cellulose (HPC), hydroxyethyl cellulose (HEC), polyacrylic acid (PAA), polystyrene maleic anhydride (SMA), optionally carboxylated butadiene-styrene copolymers (SBR), a copolymer of acrylonitrile and butadiene (NBR), α copolymer of styrene, ethylene, butylene and styrene (SEBS), a terpolymer of styrene, butadiene and vinylpyridine (SBVR), polystyrene acrylate (PSA), polytetrafluoroethylene (PTFE), a fluorinated copolymer of ethylene and propylene (FEP), polyhexafluoropropylene (PPHF), ethylvinyl alcool (EVA), zinc oxide ZnO, fibres (Ni, C, polymers), powders of compounds based on cobalt such as Co, Co(OH)₂, CoO, LiₓCoO₂, HₓCoO₂, NaₓCoO₂.

The battery separator is generally composed of polyolefin fibres (e.g. polypropylene) or nonwoven porous polyamide.

The electrolyte is a concentrated alkaline aqueous solution comprising at least one hydroxide (KOH, NaOH, LiOH), in a concentration generally of the order of several times normality.

The electrode pastes are prepared in a standard fashion, the electrodes are manufactured, then at least one cathode, a battery separator and an anode are superposed in order to constitute the electrochemical bundle. The electrochemical bundle is introduced into a container and impregnated with an aqueous alkaline electrolyte. The battery is then closed.

The invention relates to any format of batteries: prismatic format (flat electrodes) or cylindrical format (spiral or concentric electrodes).

The battery according to the invention can be of the open (open or semi-open) type or of the sealed type.

The battery according to the invention is particularly well suited as an energy source for an electric vehicle or a portable device.

### EXAMPLES

Alloys, the overall composition of which has the formula

(La, Ce, Nd, Pr)₁₋ᵤMgᵤ(Ni, Mn, Al, Co)ₜ, are produced by sintering prealloys

(La, Ce, Nd, Pr)(Ni, Mn, Al, Co)ₓ (1<x<=5) and Mg₂Ni in sealed crucibles under argon and annealed at temperatures comprised between 800 and 1100° C. for periods comprised between 1 hour and 10 days.

The elemental composition of these alloys is indicated in Table 1

TABLE 1
Elemental composition of the alloys

| Al- | | | | | | | | | | |
|---|---|---|---|---|---|---|---|---|---|---|
| loy | La | Ce | Nd | Pr | Mg | Ni | Mn | Al | Co | t |
| A | 0.7 | 0 | 0 | 0 | 0.30 | 2.80 | 0 | 0 | 0.5 | 3.3 |
| B | 0.20 | 0 | 0.20 | 0.45 | 0.15 | 3.58 | 0.02 | 0.05 | 0.05 | 3.7 |
| C | 0.60 | 0.18 | 0.07 | 0.03 | 0.12 | 4.02 | 0.13 | 0.10 | 0.25 | 4.5 |

The alloy of Example A of the prior art is characterized by an Mg level equal to u=0.30, a value of t=3.3 and a value of v=0.5.

The alloy of Example B according to the invention has a magnesium level of u=0.15, a stoichiometry of t=3.7, and a partial substitution of the nickel by Mn, Al and Co at the level v=0.12.

The magnesium level of the alloy C which is outside the invention is equal to u=0.12, its stoichiometry is equal to t=4.5 and the nickel is substituted by Mn, Al and Co at the level v=0.48.

The composition of the alloys in terms of crystalline phases is determined using the trace of X-ray diffraction diagrams, using the copper wavelength Kα₁. The composition in terms of crystalline phases is determined by following the Rietveld method (Rietveld, H. M., A profile refinement method for nuclear and magnetic structures. Journal of Applied Crystallography, 1969, 2, 6571). The compositions of alloys A, B and C in terms of crystalline phases are shown in Table 2.

TABLE 2
Composition of the alloys in terms of phases.

| | Phase (%) | | | |
|---|---|---|---|---|
| | Type | Type | Type | Type |
| Alloy | A₂B₇(R) | A₂B₇(H) | A₅B₁₉(R) | AB₅(H) |
| A | 0 | 100 | 0 | 0 |
| B | 9 | 1 | 82 | 8 |
| C | 11 | 7 | 24 | 58 |

The alloy of Example A of the prior art is constituted only by a hexagonal A₂B₇ phase A₂B₇(H) of Ce₂Ni₇ type.

The alloy of Example B according to the invention comprises 10% A₂B₇ type phases (hexagonal of Ce₂Ni₇ type or rhombohedral of Gd₂Co₇ type,), 8% hexagonal AB₅ phase of CaCu₅ type and 82% rhombohedral A₅B₁₉ type phase of Ce₅Co₁₉ type.

The alloy C which is outside the invention is characterized by the presence of 24% A₅B₁₉ phase, 18% A₂B₇ phase and 58% AB₅ phase.

A sample of alloy is coated with an epoxy resin, then polished. Different points on the polished sample are analyzed using a electronic microprobe with wavelength dispersive analysis in order to determine its composition. The B/A ratio where B is the sum of the level of Ni and of the element(s) M, and A is the sum of the La, Ce, Nd, Pr and Mg levels, is determined for each point analyzed.

The results of the analysis by electronic microprobe of the A₅B₁₉ phase of alloys A, B and C are shown in Table 3.

TABLEau 3
Composition of the A₅B₁₉ phase of the alloys.

| Alloy | La | Ce | Nd | Pr | Mg | Ni | Mn | Al | Co | B/A |
|---|---|---|---|---|---|---|---|---|---|---|
| A | No A₅B₁₉ phase | | | | | | | | | |
| B | 0.16 | | 0.14 | 0.39 | 0.19 | 3.58 | 0.03 | 0.06 | 0.07 | 3.74 |
| C | 0.45 | 0.12 | 0.05 | 0.02 | 0.21 | 3.31 | 0.12 | 0.14 | 0.28 | 3.85 |

The alloy A of the prior art does not contain any A₅B₁₉ phase.

The A₅B₁₉ phase of the alloy B according to the invention has an Mg level y equal to 0.19 and a level z of element M equal to 0.16.

The A₅B₁₉ phase of the alloy C which is outside the invention has an Mg level y equal to 0.21 and a level z of element M equal to 0.54.

The mass capacity of the alloys is determined in prismatic laboratory elements the capacity of which is limited by the anode.

The anodes comprising the alloys are constituted by a mixture of:
65% (by weight) of the alloy reduced to powder the particle size distribution of which is characterized by a Dv 50% corresponding to a size of 40 μm
30% (by weight) of nickel powder as conductive compound
5% of PTFE as binder.

Yttrium oxide is added to the anode 3 of Table 4, at a level of 0.5% yttrium with respect to the alloy mass.

The cathode comprises a standard nickel foam type current collector and an active ingredient constituted by a nickel hydroxide partially substituted by Zn and Co, the conductive network of which, constituted by Co(OH)₂ has been formed beforehand.

The anode and the cathode are separated by a polyolefin battery separator and a membrane intended to prevent any recombination of oxygen, released at the cathode, on the anode.

The electrolyte is an aqueous solution of KOH at 8.7 mole/litre.

After a first charge for 16 hours with a current of 40 mA per gram of alloy (charge for 16 hours at 40 mA/g), the alloy is activated over 10 cycles under the following conditions:
Discharge at 80 mA/g, cut-off voltage=0.9 V.
recharge for 16 hours at 40 mA/g
rest for 1 hour.

Then the batteries are cycled under the following conditions:
discharge for 48 minutes at 400 mA/g, cut-off voltage=0.9 V.
recharge for 52 minutes at 400 mA/g.

By alloy life span is meant the number of cycles corresponding to a discharged capacity equal to 80% of the maximum capacity measured during the activation period.

The capacities and life span in an open element is shown in Table 4.

TABLE 4
Discharged initial capacity and life span of the anodes

| | Anode | | | |
|---|---|---|---|---|
| | 1 | 2 | 3 | 4 |
| Alloy | A | B | B | C |
| Y₂O₃ (Y/alloy = 0.5% by mass) | no | no | yes | no |
| Q (mAh/g) | 367 | 358 | 355 | 323 |
| Life span (cycles) | 153 | 257 | 398 | 174 |

The maximum capacity restored during activation by the anode 1 for which the active ingredient is the alloy A of the prior art is equal to 367 mAh/g. However, it decreases rapidly during cycling in order to reach 80% of the initial capacity at cycle 153.

The maximum capacity restored during activation by the anode 2 for which the active ingredient is the alloy B of the invention is equal to 358 mAh/g. The life span of this anode 2 is 257 cycles.

The anode 3 contains alloy B of the invention and yttrium oxide. The maximum capacity restored during the activation by this series is 355 mAh/g and its life span is 398 cycles.

The capacity of the anodes 2 and 3 is greater than 320 mAh/g, which is the mass capacity of the NiMH batteries of the prior art.

The addition of yttrium oxide to the anode 3 makes it possible to prolong the life span of the anode by 141 cycles compared with the anode 2.

The maximum capacity restored during activation by the anode 4, for which the active ingredient is the alloy C which is outside the invention, is equal to 323 mA/g. This is attributed to the large quantity of AB₅ type phase contained in this alloy. Its life span is limited to 174 cycles.

1. Electrode comprising an active ingredient comprising a hydrogen-absorbing alloy comprising at least one crystalline phase of type A₅B₁₉ having the formula R_{1-y}Mg_{y}Ni_{3.8±0.1-z}M_{z}, in which:
R represents one or more elements chosen from
La, Ce, Nd or Pr;
M represents one or more elements chosen from
Mn, Fe, Al, Co, Cu, Zr, Sn and M does not contain Cr;
0≦y≦0.30;
z≦0.5.

2. Electrode according to claim 1, in which the sum of the stoichiometric indices of nickel and M is 3.8.

3. Electrode according to claim 1, in which y≦0.25.

4. Electrode according to claim 1, in which y>0.15.

5. Electrode according to claim 1, in which z≦0.30.

6. Electrode according to claim 1, in which the stoichiometric index of each of the nickel substituents is less than or equal to 0.20.

7. Electrode according to claim 6, in which the stoichiometric index of each of the nickel substituents is less than or equal to 0.15.

8. Electrode according to claim 1, in which M represents one or 30 more elements chosen from Co, Al and Mn.

9. Electrode according to claim 1, in which M is CoaAl_{b}, with a≦0.15 and b≦0.15.

10. Electrode according to claim 1, wherein the overall composition of the hydrogen-absorbing alloy has the formula:
R₁₋ᵤMgᵤNiₜ₋ᵥMᵥ where
0≦u≦0.25;
3.5≦t≦4.3;
v≦0.5.

11. Electrode according to claim 10, in which the crystalline phase A₅B₁₉ represents at least 50% by volume of the alloy.

12. Electrode according to claim 1, in which the equilibrium pressure of the alloy at 40° C., for 1% by mass of hydrogen inserted, is less than 1.5 bar.

13. Electrode according to claim 1, in which the size of the alloy particles is characterized by a Dv 50% of 30 to 120 μm, preferably of 50 to 100 μm.

14. Electrode according to claim 1, in which the size of the alloy particles is characterized by a Dv 50% of 120 to 200 gm.

15. Electrode according to claim 1, also comprising an yttrium-based compound.

16. Electrode according to claim 15, in which the yttrium compound is an oxide such as Y₂0₃, an hydroxide such as Y(OH)₃ or an yttrium salt.

17. Electrode according to claim 16, in which the mass of yttrium represents from 0.1 to 2% of the mass of the alloy, preferably from 0.2 to 1% of the mass of the alloy, also preferably from 0.2 to 0.7% of the mass of the alloy.

18. Nickel metal hydride alkaline storage battery comprising at least one negative electrode, which is an electrode according to claim 1.
